(19) United States
(12) Patent Application Publication
(10) Pub. No.: US 2026/0220640 A1
(43) Pub. Date: Jul. 30, 2026

(54) TRANSACTION VERIFICATION SCRIPT GENERATION SYSTEM AND METHODS

(71) Applicant: ACTIMIZE LTD, Ra'anana (IL)

(72) Inventors: Shubh VACHHER, Chennai (IL); Kunal PATRIKAR, Pune (IL); Anish BABU, Pimpri-Chinchwad (IL)

(21) Appl. No.: 19/037,734

(22) Filed: Jan. 27, 2025

(51) Int. Cl. G06Q 20/40; G06Q 20/42

(52) U.S. Cl. CPC G06Q 20/4016; G06Q 20/42

(57) ABSTRACT

A system is adapted to automatically verify a suspicious transaction. The system includes a fraud analyst computing device configured to perform operations. The operations include: electronically receiving an alerted transaction associated with a customer, with the risk factor identification module, automatically identifying a plurality of risk factors associated with the alerted transaction, electronically transmitting the plurality of risk factors and a custom prompt to the summary engine, and electronically receiving, from the summary engine, a transaction verification call script based on the plurality of risk factors and the custom prompt.

### TECHNICAL FIELD

The subject matter described herein relates to devices, systems, and methods for automated generation of transaction verification scripts. This verification script generation system has particular but not exclusive utility for detection of fraudulent financial transactions.

### BACKGROUND

When bank customers make suspicious transactions, fraud analysts sometimes need to make voice calls or send email or Simple Messaging Service (SMS) messages to the customer to verify whether the transaction is legitimate. Current transaction verification processes can be time-consuming and are often conducted by customer agents, leading to inconsistencies, inefficiencies and delays, and a lack of standardized experience for account holders. A significant obstacle to automation is the distinct circumstances surrounding each transaction, making the automated creation of transaction verification scripts difficult.

Existing solutions are often primitive. For example, the industry currently uses pre-recorded messages, or SMS templates to send text messages to customers. These are generic and not very engaging, and may require an analyst to fill in certain blanks. Efficiency of fraud analysts and customer agents is a key business metric to optimize for in the compliance industry, so any time spent on verification calls or text messages is potentially detrimental. Accordingly, a need exists for improved transaction verification systems and methods that address the foregoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a verification script generation system. The present disclosure makes novel use of a Large Language Model (LLM) generative AI (GenAI) system that combines LLM-generated personalized call scripts with proprietary risk factors to automate transaction verification call script generation. The specific combination of proprietary risk factors generated for each alert, along with a custom script to guide the LLM, allows for the rapid creation of a personalized script for each alerted transaction. This helps reduce the workload of customer agents and/or fraud analysts, and provides a curated experience for each account holder for each of their alerted transactions. This saves fraud analyst time and helps to standardize the customer experience.

The verification script generation system disclosed herein has particular, but not exclusive, utility for detection of fraudulent financial transactions and related management of anti-fraud activities.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically verify a suspicious transaction. The system also includes a fraud analyst computing device having a processor and a non-transitory computer readable medium operably coupled thereto, the fraud analyst computing device may include a graphical user interface (GUI) and a risk factor identification module and being in electronic communication with a summary engine, the computer readable medium including a plurality of instructions stored in association therewith that are accessible to, and executable by, the processor, to perform operations which may include: electronically receiving an alerted transaction associated with a customer; with the risk factor identification module, automatically identifying a plurality of risk factors associated with the alerted transaction; electronically transmitting the plurality of risk factors and a custom prompt to the summary engine; and electronically receiving, from the summary engine, a transaction verification call script based on the plurality of risk factors and the custom prompt. Other embodiments of this aspect include corresponding computer systems, apparatus, and computer programs recorded on one or more computer storage devices, each configured to perform the actions of the methods.

Implementations may include one or more of the following features. In some embodiments, the operations may further include: with the GUI, within 1 second of receiving the alerted transaction, displaying the transaction verification call script to a user. In some embodiments, the operations may further include: automatically contacting the customer associated with the alerted transaction; if the customer is reached by the contact: automatically communicating the transaction verification call script to the customer; automatically requesting, from the customer, an indication of whether the alerted transaction is valid or fraudulent; automatically receiving and interpreting the indication from the customer; if the indication indicates that the alerted transaction is valid, automatically allowing the alerted transaction; and if the indication indicates that the alerted transaction is fraudulent, automatically blocking the alerted transaction. In some embodiments, the operations further include: if the customer is not reached by the contact: automatically placing a hold on the alerted transaction; and with the GUI, displaying the alerted transaction to a user. In some embodiments, the operations may further include receiving, via the GUI, from a user, an instruction to contact the customer. In some embodiments, the fraud analyst computing device may further include an interactive voice response (IVR) system, where the contact is an automated voice contact generated by the IVR system. In some embodiments, the summary engine may include a large language model. In some embodiments, the custom prompt includes corresponding definitions and criticalities for the plurality of risk factors. In some embodiments, the custom prompt includes instructions to avoid technical jargon, to be concise, and to avoid fearmongering. In some embodiments, the custom prompt includes instructions to mention at least some of the plurality of risk factors in a single sentence, in order of corresponding criticalities. Implementations of the described techniques may include hardware, a method or process, or computer software on a computer-accessible medium.

One general aspect includes a computer-implemented method. The computer-implemented method includes, with a fraud analyst computing device having a processor and a non-transitory computer readable medium operably coupled thereto, the fraud analyst computing device including a graphical user interface (GUI) and a risk factor identification module and being in electronic communication with a summary engine, the computer readable medium including a plurality of instructions stored in association therewith that are accessible to, and executable by, the processor electronically receiving an alerted transaction associated with a customer; with the risk factor identification module, automatically identifying a plurality of risk factors associated with the alerted transaction; electronically transmitting the plurality of risk factors and a custom prompt to the summary engine; and electronically receiving, from the summary engine, a transaction verification call script based on the plurality of risk factors and the custom prompt. Other embodiments of this aspect include corresponding computer systems, apparatus, and computer programs recorded on one or more computer storage devices, each configured to perform the actions of the methods.

Implementations may include one or more of the following features. In some embodiments, the operations may further include: with the GUI, within 1 second of receiving the alerted transaction, displaying the transaction verification call script to a user. In some embodiments, the operations may further include: automatically contacting the customer associated with the alerted transaction; if the customer is reached by the contact: automatically communicating the transaction verification call script to the customer; automatically requesting, from the customer, an indication of whether the alerted transaction is valid or fraudulent; automatically receiving and interpreting the indication from the customer; if the indication indicates that the alerted transaction is valid, automatically allowing the alerted transaction; and if the indication indicates that the alerted transaction is fraudulent, automatically blocking the alerted transaction. In some embodiments, the operations further include: if the customer is not reached by the contact: automatically placing a hold on the alerted transaction; and with the GUI, displaying the alerted transaction to a user. In some embodiments, the operations may further include receiving, via the GUI, from a user, an instruction to contact the customer. In some embodiments, the fraud analyst computing device may further include an interactive voice response (IVR) system, where the contact is an automated voice contact generated by the IVR system. In some embodiments, the summary engine may include a large language model. In some embodiments, the custom prompt includes corresponding definitions and criticalities for the plurality of risk factors. In some embodiments, the custom prompt includes instructions to avoid technical jargon, to be concise, and to avoid fearmongering. In some embodiments, the custom prompt includes instructions to mention at least some of the plurality of risk factors in a single sentence, in order of corresponding criticalities. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the verification script generation system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is an exemplary representation of a fraud management system, in accordance with at least one embodiment of the present disclosure.

FIG. 2 is an exemplary representation of a verification script generation system, in accordance with at least one embodiment of the present disclosure.

FIG. 3 is a schematic, diagrammatic representation, in block diagram form, of an example hardware architecture or network architecture for a verification script generation system, in accordance with at least one embodiment of the present disclosure.

FIG. 4 is a screen display for an example verification script generation system, in accordance with at least one embodiment of the present disclosure.

FIG. 5 is a screen display for an example verification script generation system, in accordance with at least one embodiment of the present disclosure.

FIG. 6 is a schematic, diagrammatic representation, in flow diagram form, of an example automated transaction verification method, according to at least one embodiment of the present disclosure.

FIG. 7 is a schematic, diagrammatic representation, in block diagram form, of an example copilot module, in accordance with at least one embodiment of the present disclosure.

FIG. 8 is a schematic, diagrammatic representation, in block diagram form, of an example copilot module, in accordance with at least one embodiment of the present disclosure.

FIG. 9 is a schematic, diagrammatic representation, in block diagram form, of at least a portion of an example categorizer, in accordance with at least one embodiment of the present disclosure.

FIG. 10 is a schematic, diagrammatic representation, in block diagram form, of at least a portion of an example verification script generation system, in accordance with at least one embodiment of the present disclosure.

FIG. 11 is a schematic, diagrammatic representation, in block diagram form, of at least a portion of an example verification script generation system, in accordance with at least one embodiment of the present disclosure.

FIG. 12 is a schematic diagram of a processor circuit, in accordance with at least one embodiment of the present disclosure.

### DETAILED DESCRIPTION

In accordance with at least one embodiment of the present disclosure, a verification script generation system is provided that employs a Large Language Model (LLM) generative AI (GenAI) system that combines LLM-generated personalized call scripts with proprietary risk factors from a fraud analysis product (e.g., NICE Xceed) to automate transaction verification contact script generation, as well as the customer contact regarding the transaction verification itself. The specific combination of proprietary risk factors generated for each alert, along with a custom script to guide the LLM, allows for the rapid creation of a personalized script for each alerted transaction. This helps reduce the workload of customer agents and/or fraud analysts, and provides a curated experience with personalized details for each account holder for each of their alerted transactions. This saves fraud analyst time and helps to standardize and personalize the customer experience.

The system disclosed herein uses the LLM to transform a unique combination of risk factors for each transaction into a very few sentences (e.g., one sentence or two sentences) in layman's language. A concise output may be necessary to minimize or avoid loss of account holder interest or attention. In a novel twist, the system may use the LLM to decide on the order in which risk factors are mentioned. Due to the unique combinations of risk factors that can trigger for each transaction, this is a combinatorial problem which the system uses the LLM itself to resolve. Depending on the implementation, the LLM can also choose to exclude certain risk factors from being mentioned (e.g., lower-criticality risk factors) in the script if the script is getting too long, to keep it concise. In this case, “too long” is again left up to the “judgment” of the LLM, which may be based on instructions passed to it in the custom prompt.

Efficiency of the analyst is a key business metric to optimize for in the compliance industry. If the transaction verification calls are automated, then the analyst can spend less time in identifying which alerted transactions are in fact fraudulent, and which are legitimate. This can then improve the efficiency of fraud desk analysts in terms of reduction of time and cost. Further, this will help standardize the customer experience, while also personalizing it appropriately, thus driving trust and improving customer satisfaction.

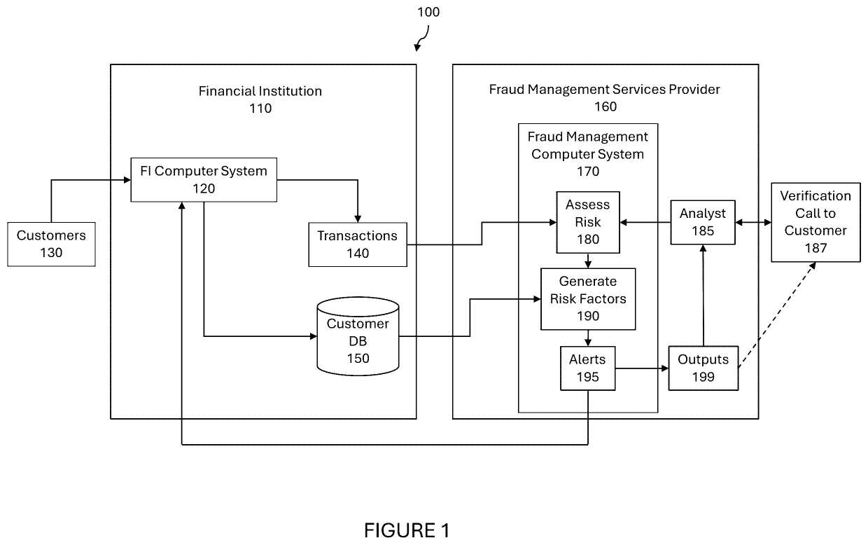

The alerts that a risk-analysis product generates have associated risk factors generated alongside (example: American Bankers Association (ABA) routing number risk, beneficiary location risk, etc.). These risk factors are provided to the LLM as user_input. The LLM has been set up with a system_prompt (see below) that clearly defines its intended output given the risk factors and transaction as an input. In FIG. 1, the script generated by the LLM is shown on the right-hand side. This workflow may for example be incorporated into existing products (e.g., NICE FraudDesk Co-Pilot).

Here is an example of a custom system_prompt that is fed to the LLM:

A finance company analyzes each transaction done by a user of a bank and gives it a few out of the following comprehensive list of risk factors, in order of descending criticality:

RF1-Risk Factor 1
RF2-Risk Factor 2
. . .

I will give you the risk factors involved in a particular transaction of a user and few details about the user's profile, you will create a writeup on the basis of these risk factors, personalized with the user's details to improve engagement, that can be understood by the layman user in an automated call to him.

While creating a writeup, make sure of following things:
The writeup should strictly have no technical jargon; therefore, don't even mention the risk factor abbreviations given in the comprehensive list above, but rather, in simple, human understandable form, give a brief summary of why the call was being made. Thus, refrain from using words like “beneficiary”, “watch list” and rather use “[beneficiary name]”, “known list of suspicious account holders”.
The order you mention the risk factors in should be according to the criticality of the risk factor. This can be in such a way that the user becomes maximally alert and focused on the message right after hearing the first risk factor's explanation; put the user into alert listening mode asap. For example, given that the risk factors indicate “the user has transacted on an unusual day of the week which is not common given their transaction profile” and “the user is transacting with an account on a watch list”, first mention the watch list risk factor since it's more critical and alarming to a layman user.
The script should combine many risk-factor-descriptions into one coherent sentence while not compromising human understanding and delivery clarity. The user should not lose interest in what is being discussed in the call message and thus we can't overload them with a long winding speech.
You don't need to mention each and every risk factor. Only mention the ones which are critical to any customer and have a larger impact.
Don't focus on niceties like asking user to contact customer care, or assuring him that his funds are safe, but rather, given the risk factors that have been alerted for it, focus on these particularities of the transaction.
Keep it as concise as possible
Make sure there is no fearmongering language

This custom prompt, along with the risk factors and details of the alerted transaction, are then passed to the LLM as user_input, thus prompting the LLM to generate an output such as:

We noticed a recent payment of $100,000 to Anushri Builders Inc in Mumbai. As we see that this transaction is quite unusual for you as your usual transaction amount range is between $5000 to $10,000 and your usual transaction location is Chennai. Moreover, this is the first time you are making a transaction to Anushri Builders Inc.

This output is then used as a script by an Interactive Voice Response (IVR) system, which automatically places a voice call and prompts the account holder to verify or decline the transaction, or by an equivalent SMS system to communicate with the account holder by text message.

The present disclosure aids substantially in transaction verification, by improving the quality and uniformity of verification contact scripts. Implemented on a fraud management computer system in communication with a customer communication device such as a smartphone, the verification script generation system disclosed herein provides practical improvement in the ability to contact and receive approval or rejection of a transaction by an account holder. This improved transaction verification methodology transforms a slow, manual, experience-driven process into one that occurs automatically, in real time, without the normally routine need to provide analysts with script templates and have them place verification phone calls, or send emails or SMSs manually. This unconventional approach improves the functioning of the fraud management computer system, by reducing the amount of time required to verify a suspicious transaction, thus reducing cost, energy consumption and the greenhouse gas emissions associated therewith.

The verification script generation system may be implemented as a process at least partially viewable on a display, and operated by a control process executing on a processor that accepts user inputs from a keyboard, mouse, or touchscreen interface, and that is in communication with one or more databases and one or more customer communication devices. In that regard, the control process performs certain specific operations in response to different inputs or selections made at different times. Outputs of the verification script generation system may be printed, shown on a display, texted, emailed, read aloud, or otherwise communicated to human operators and/or customers. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the verification script generation system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one of ordinary skill in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

FIG. 1 is an exemplary representation of a fraud management system 100, in accordance with at least one embodiment of the present disclosure. The fraud management system 100 includes a financial institution 110 and a fraud management services provider 160. The financial institution (FI) 110 uses inputs from customers 130 into an FI computer system 120 to generate transactions 140, as well as customer data that may be sored for example in a customer database 150.

The fraud management services provider 160 includes a fraud management computer system or fraud analyst computing device 170 that receives the transactions 140 and data from the customer database 150, and performs a risk assessment step 180. Based on the risk assessment step 180, the fraud management computer system 170 performs a risk factor generation step 190, and then generates alerts 195 if any risk factors or risk scoring exceeds a threshold (e.g., if any “red” or “yellow” level risk factors are found, or if a risk score exceeds a value of 75%). The alerts 195, along with other outputs 199 (e.g., customer data, transaction details, etc.) are then sent to an analyst 195, who may place a verification call 187 to a customer associated with an alerted transaction. In some embodiments, the verification call 187 is placed by the fraud management computer system 170 itself.

Before continuing, it should be noted that the examples described above are provided for purposes of illustration, and are not intended to be limiting. Other devices and/or device configurations may be utilized to carry out the operations described herein.

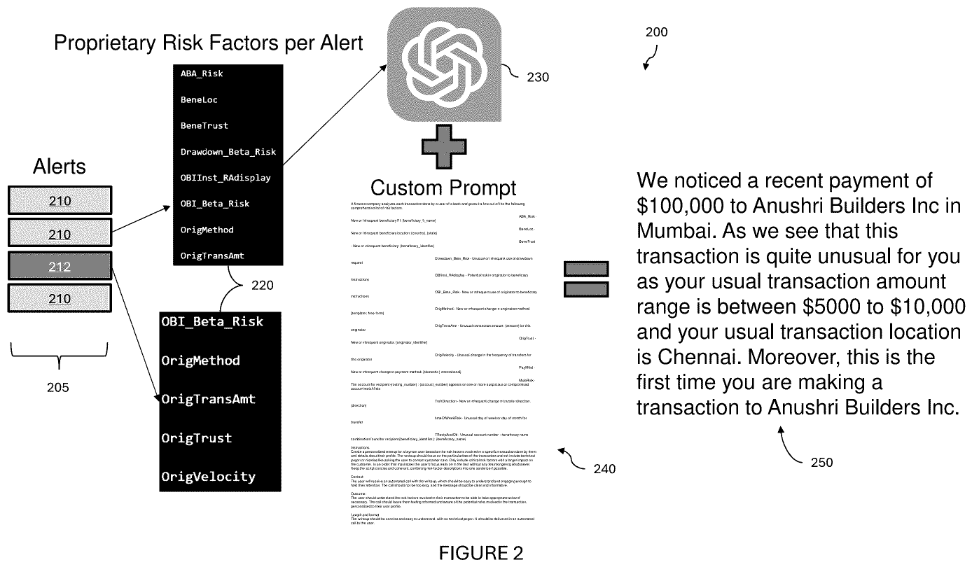

FIG. 2 is an exemplary representation of a verification script generation system 200, in accordance with at least one embodiment of the present disclosure. Alerts 205 can include “yellow” or moderate-risk alerts 210 and/or “red” or high-risk alerts 212. Each alert 205 is associated with a grouping of proprietary risk factors 220, which can be combined with a custom prompt 240 and fed to an LLM 230. The custom prompt may for example include generic instructions to the LLM, along with definitions of the possible risk factors, as well as their importance relative to one another. The LLM 230 then produces a transaction verification script 250 that includes details of the alerted transaction and a summary of the most relevant risk factors.

In the example shown in FIG. 2, the risk factors include ABA_Risk (a risk factor associated with the account number of the beneficiary of the transaction) and BeneLoc, (a risk factor associated with the geographic location of the beneficiary). In an example, these risk factors may be provided to the LLM through a string variable called user_input, once the LLM has been set up with a prompt string called system_prompt that clearly defines its intended output given the risk factors and alerted transaction as an input. This script generation system 200 can be integrated into existing fraud management software such as NICE FraudDesk Co-Pilot.

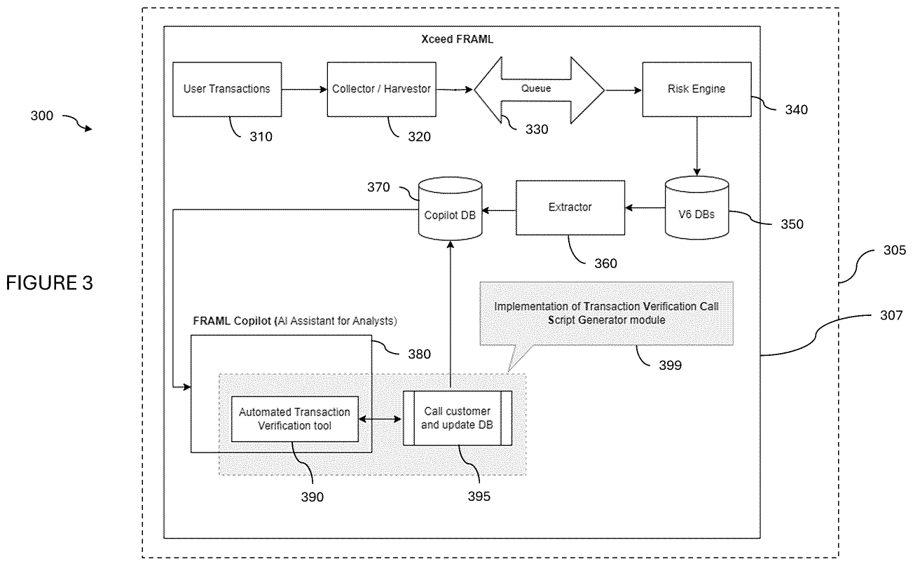

FIG. 3 is a schematic, diagrammatic representation, in block diagram form, of an example hardware architecture or network architecture for a verification script generation system 300, in accordance with at least one embodiment of the present disclosure. The system 300 may for example include an environment 305 such as Microsoft Azure OpenAI Playground running an application 307 such as NICE Xceed FRAML. The application 307 receives user transactions 310, which may for example be the transactions initiated by customers, which are to be monitored for potential fraud. These transactions 310 are fed into the system as the primary input for further analysis.

The application includes a collector/harvester 320, which gathers and collects transaction data from various sources, such as banking systems or payment gateways, for analysis. This ensures all relevant transaction details are available for processing.

A queue 330 acts as a buffer that holds transaction data temporarily before it is sent to the risk engine or risk factor identification module 340. This ensures smooth processing by handling data flow and minimizes or prevents overloading of the risk engine 340. The risk engine 340 analyzes the transactions 310 for potential fraud using predefined rules and machine learning models. It assigns risk factors to flagged transactions based on suspicious patterns or behaviors, and communicates with a database 350, which stores historical transaction data, user profiles, and risk-related metadata. The risk engine 340 queries this database 350 for insights and comparisons during the risk analysis process based on transaction patterns and historical data. An extractor 360 retrieves transaction-related risk factors and other details from the database(s) 350 and sends them to the copilot database 370 for further processing. The copilot database 370 may for example be a dedicated database for the copilot module 380. The copilot database 370 stores transaction alerts, risk factors, and other data used by the analysts and automated tools, and serves as the central data hub for the copilot module 380.

The copilot module 380 (e.g., an application such as NICE FRAML CoPilot) may for example be an AI-powered assistant designed to aid fraud analysts, and may include an automated transaction verification tool 390, which automates the generation of transaction verification call scripts using a novel transaction verification call script generation module 399. The call script generation module 399 places a call 395 to the customer, and updates information in the copilot database 370. The call 395 may be initiated using interactive voice response (IVR), if available, or allows analysts to manually call to verify transactions using the generated scripts. The system 300 takes automated actions, generates personalized and concise call scripts by combining transaction details with risk factors in layman-friendly language, and records the outcomes (e.g., verified, rejected, or on hold) in the database 370.

Block diagrams are provided herein for exemplary purposes; a person of ordinary skill in the art will recognize myriad variations that nonetheless fall within the scope of the present disclosure. For example, any of the blocks described herein may optionally include an output to a user of information relevant to the block, and may thus represent an improvement in the user interface over existing art by providing information (whether static or dynamically updated) that is not otherwise available.

Similarly, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

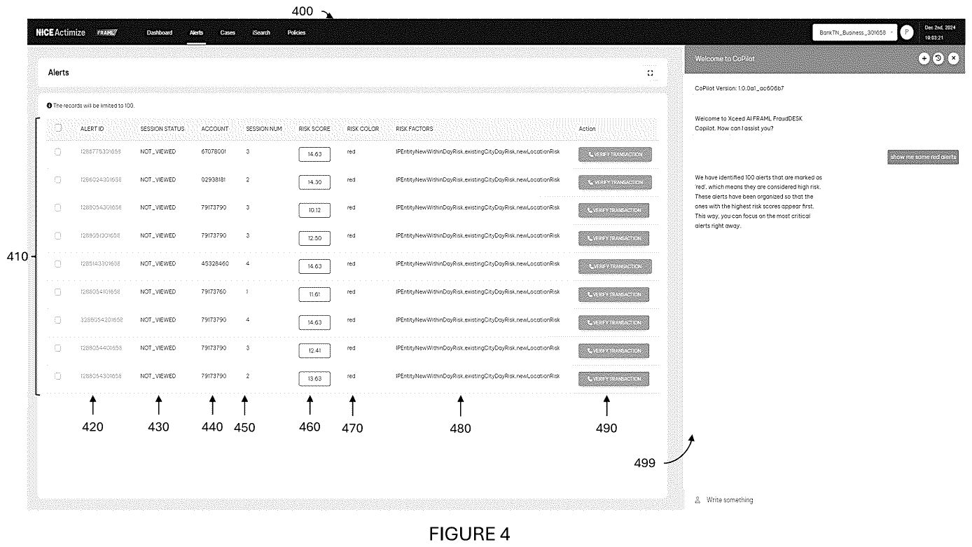

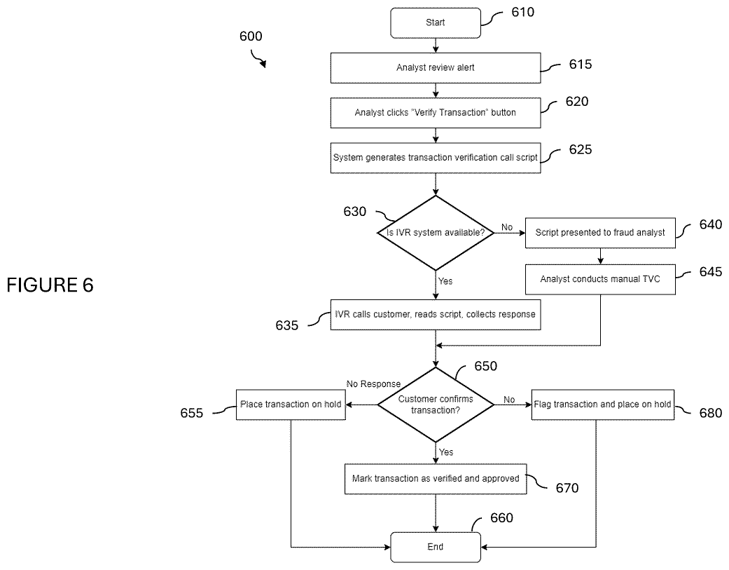

FIG. 4 is a screen display 400 for an example verification script generation system, in accordance with at least one embodiment of the present disclosure. The screen display may for example be part of a graphical user interface (GUI) for the verification script generation system. The screen display 400 includes a number of alerted transactions 410, each of which includes a unique numerical alert ID 420, a session status 430 (which may for example be “viewed” or “not viewed), an account number 440 for the originating account, a session number 450 (which may for example represent the order of sessions (e.g., the first session, second session, etc.) for a specific account, where multiple rows with the same “Session Num” mean that multiple activities or events happened during that session), a risk score 460 (which may for example be a numerical value between 0 and 20, with higher scores indicating higher risk that the transaction is fraudulent), a risk color 470 (which may for example be “red”, “yellow”, or “green”), an alert-specific collection of risk factors 480 associated with the alert 410, and an action button 490 which can be used to generate an alert-specific script and call the associated account holder for the originating account, as shown for example in FIG. 6, below. The screen display 400 also includes an AI chat window 499, which may be used to issue instructions to the copilot module to, for example, show the analyst a new batch of alerts or alerted transactions 410.

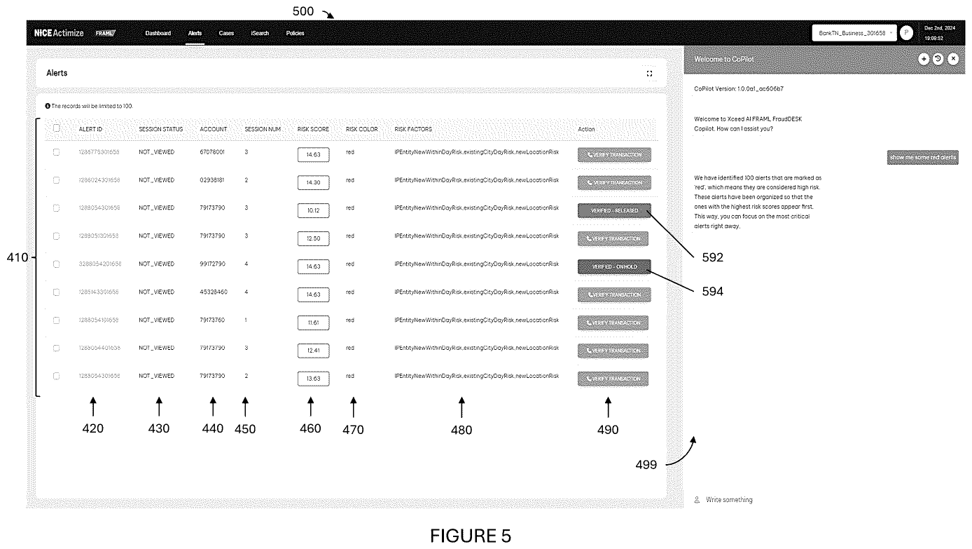

FIG. 5 is a screen display 500 for an example verification script generation system, in accordance with at least one embodiment of the present disclosure. Visible are the alerted transactions 410, alert IDs 420, a session statuses 430, account numbers 440, session numbers 450, a risk scores 460, risk colors 470, risk factors 480, action buttons 490, and AI chat window 499. The screen display 500 of FIG. 5 is similar to the screen display 400 of FIG. 4, except that one of the action buttons 490 has been pressed, resulting in a “verified—released” status 592 (e.g., the system has called the customer and received verification of the transaction), and another of the action buttons 490 has been pressed, resulting in a “verified—on hold” status 594 (e.g., the system has called the customer but failed to make contact). Other statuses for the action buttons 490 may include “Verify Transaction”, “Verified-Released”. Still other values are contemplated and may be used instead or in addition, without departing from the spirit of the present disclosure.

FIG. 6 is a schematic, diagrammatic representation, in flow diagram form, of an example automated transaction verification method 600, according to at least one embodiment of the present disclosure. It is understood that the steps of method 600 may be performed in a different order than shown in FIG. 6, additional steps can be provided before, during, and after the steps, and/or some of the steps described can be replaced or eliminated in other embodiments. One or more steps of the method 600 can be carried by one or more devices and/or systems described herein, such as components of the system 100, 200, or 300, and/or processor circuit 1250.

In the copilot module, analysts have the capability to efficiently verify transactions flagged as suspicious. For each alert, a “Verify Transaction” button is available. When the analyst clicks this button, a transaction verification call script is automatically generated. The generated script forms the core of this process and is designed to facilitate seamless customer interaction. If an Interactive Voice Response (IVR) system is available, it can automatically initiate a call to the customer, read out the script, and collect their response. The system handles the response as follows: If the customer confirms the transaction, it is marked as verified and approved. If the customer denies the transaction, it is flagged and either blocked or placed on hold. If the call fails to connect or the customer does not respond, the transaction may be placed on hold, or in some embodiments, it may be blocked.

However, if an IVR system is not available, the process remains effective. The script is instead presented to the fraud analyst, who can use it to conduct a manual transaction verification call (TVC). The script ensures consistency, clarity, and efficiency in communication, regardless of whether the process is automated or manual. This flexibility in script usage enables the verification script generation system to enhance the transaction verification process across a variety of system configurations, reducing the workload on analysts and improving the overall customer experience.

In step 610, the method 600 includes starting the method. Execution then proceeds to step 615.

In step 615, the method 600 includes showing the alert to the analyst for review. Execution then proceeds to step 620.

In step 620, the method 600 includes receiving a user input (e.g., a button click) from the analyst instructing the system to verify the transaction. Execution then proceeds to step 625.

In step 625, the method 600 includes generating a transaction-specific, alert-specific transaction verification call script or contact script. Execution then proceeds to step 630.

In step 630, the method 600 includes determining whether an interactive voice response (IVR) system is available. If yes, execution then proceeds to step 635. If no, execution then proceeds to step 640.

In step 635, the method 600 includes using the IVR system to call or text the customer, read the script, and solicit and collect the customer's response. Execution then proceeds to step 650.

In step 640, the method 600 includes presenting the script to the fraud analyst. Execution then proceeds to step 645.

In step 645, the method 600 includes waiting while the analyst conducts a manual transaction verification call and enters the customer's response. Execution then proceeds to step 650.

In step 650, the method 600 includes determining whether the customer has confirmed the transaction. If yes, execution then proceeds to step 670. If no, execution then proceeds to step 680. If no response, execution then proceeds to step 655.

In step 655, the method 600 includes placing the transaction on hold. Execution then proceeds to step 660.

In step 660, the method 600 includes ending the method 600. The method 600 is now complete.

In step 670, the method 600 includes marking the transaction as verified and approved. Execution then proceeds to step 660.

In step 680, the method 600 includes flagging the transaction as fraudulent and placing the transaction on hold. Execution then proceeds to step 660.

Flow diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information (whether static or dynamically updated) that is not otherwise available.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, when the analyst clicks the “verify transaction” button”, it may be necessary for the system to generate the verification script and place the verification call to the customer within 1 second in order to avoid an impression of lag or latency on the part of the fraud analyst.

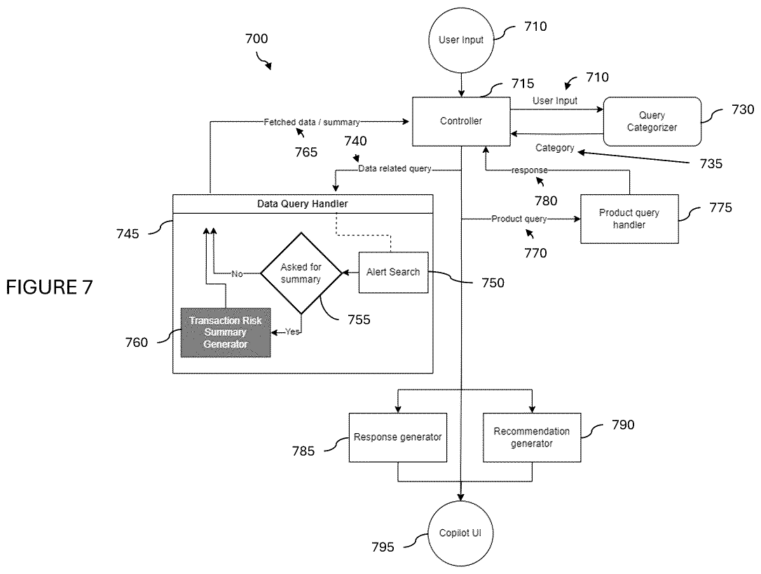

FIG. 7 is a schematic, diagrammatic representation, in block diagram form, of an example copilot module 700, in accordance with at least one embodiment of the present disclosure. The copilot module 700 may be or include a large language model. Visible are a user input 710, controller 715, and a query categorizer 730 that receives the user input 710 and returns a category 735. If the category 735 indicates that the user input is a data-related query 740, it is received by a query data handler 745 which performs an alert search 750, and makes a determination 755 whether a summary has been requested. If yes, the summary request is passed to a transaction risk summary generator or summary engine 760. Then, regardless of yes or no, the data query handler passes the fetched data and/or summary 765 back to the controller 715.

If the category 735 indicates that the user input 710 is a product query 770, then the product query 770 is received by a product query handler which produces a response 780 that is passed back to the controller 715. The controller 715 may then pass data directly to the copilot user interface 795, and/or to a response generator 785, and/or to a recommendation generator 790, each of which may also pass data to the copilot user interface 795.

The result is that the copilot module produces a response to the user input, which may include a formatted or summarized version of the fetches data/summary 765, the response 780, and the outputs of the response generator 785 and the recommendation generator 790. This response to the user input is then displayed or otherwise communicated by the user interface 795.

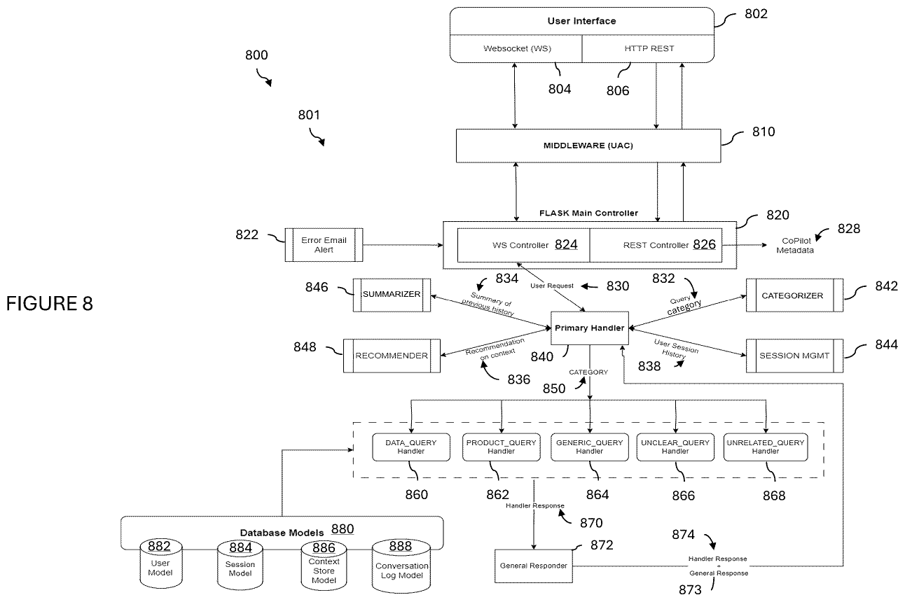

FIG. 8 is a schematic, diagrammatic representation, in block diagram form, of an example copilot module 800, in accordance with at least one embodiment of the present disclosure. Visible is a user interface 802, which is an entry point for user interaction that connects to backend processes via a WebSocket (WS) 804 and hypertext transfer protocol representational state transfer (HTTP REST) 805.

Authentication and Routing are handled by middleware user account control (UAC) 810, which acts as an intermediary between the user interface 802 and the backend 801, and also handles authentication.

Core processing is controlled by a flask main controller 820, which is a central component directing information flow, and branches to two sub-controllers: a WebSocket controller 824 which handles WebSocket messages and routes, and a REST controller 826, which handles HTTP-based application program interface (API) messages and routes.

Processing of user requests 830 is handled by a primary handler 840, which Receives user requests 830, categorizes them (e.g., as Data, Product, Generic, Unclear, or Unrelated Queries). Query categories 832 are determined by a categorizer 842, which assists the primary handler 840 in categorization of user requests 830. Depending on the implementation, the categorizer 842 might be a separate module or might be integrated within the primary handler 840.

Depending on a category 850 from the primary handler 840, a specific handler is responsible for dealing with the user request 830: a data query handler 860, a product query handler 862, a generic query handler 864, an unclear query handler 866, or an unrelated query handler 868. For response generation, each handler can interact with: a summarizer 846 (which provides summaries 834 of user conversation history), a recommender 848 (which generates context-based question recommendations 836), and/or a session manager 844 (which stores or returns the user session history 838).

A general responder 872 collects responses 870 from the various handlers and adds a general natural language response 873 to produce a final response 874, which is then returned to the primary handler 840 to, for example, be displayed via the user interface 802.

Data storage is performed by database models 880, which represent the data structures used to store information, including a user model 882, session model 884, context store model 886, conversation log model 888, and others as needed to perform the functions described herein. All components except the user interface 802 are presumed to reside on the backend. The database models 880 interact with the various handlers and the primary handler 840 for data retrieval and storage.

“User Interaction” refers to the user's entry point for interacting with the system. It consists of two main parts, first of which is the user interface (UI or GUI) 802, which is the visual element that users see and interact with. It can take various forms depending on the specific implementation, such as a website, mobile app, chatbot interface, or voice assistant interface. The UI provides functionalities for users to: enter their queries or questions through text input, voice commands, or other interactive elements; view the system's responses and recommendations; and potentially navigate through different functionalities within the copilot module (if applicable).

The second part of “user interaction” is the communication protocols which define the way the UI communicates with the backend 801 of the copilot module 800 to send user input and receive responses. The architecture describes two communication methods: WebSocket (WS): This is a real-time communication protocol that allows for real-time, bi-directional communication between the UI and the backend. This enables features like instant messaging or voice chat functionalities within the copilot module. The second communication method is HTTP REST, which is a more traditional web communication protocol used for sending requests (user queries) and receiving responses from the backend. This is suitable for scenarios where real-time updates to the user interface aren't necessary.

In an example, the user interacts with the UI 802 (e.g., types a question or uses voice commands). The UI processes the user input and converts it into a format understandable by the copilot module backend 801. Depending on the chosen communication protocol . . . with WebSocket, the UI establishes a persistent connection with the backend and sends the user input through the WebSocket channel, whereas with HTTP REST, the UI formulates an HTTP request containing the user input and sends it to the backend through a specific universal resource locator (URL). The backend 801 receives the user input through the chosen protocol.

The backend 801 processes the user input and interacts with other components within the copilot module 800 (e.g., categorizing the query, fetching data, generating responses). The backend 801 then generates a response 874 based on the processing results. The response 874 is sent back to the UI 802 through the chosen communication protocol. The UI 802 receives the response 874, interprets it, and displays it to the user in a user-friendly format. Thus, the user interaction serves as a bridge between the user and the copilot module, facilitating the flow of information and providing a seamless user experience.

The middleware (UAC) 810 acts as a gatekeeper, positioned strategically between the user interface 802 and the core functionalities of the backend 801 of the copilot module 800. This placement ensures that all incoming requests and interactions from the user interface 802 pass through the middleware 810 before reaching the internal systems. A core responsibility of the middleware 810 is to enforce user access control (UAC), leveraging the principles of a pre-defined UAC system to verify whether incoming requests originate from authorized users. This verification process typically involves authentication mechanisms, such as checking login credentials or verifying tokens. By implementing these measures, the middleware 810 safeguards the copilot module's integrity and protects sensitive data from unauthorized access.

However, the middleware 810 can have potential additional functionalities. While the architecture description focuses on UAC, the Middleware can also encompass a broader range of capabilities, depending on the specific implementation. For example, the middleware 810 could act as a preliminary checkpoint, validating the format and content of messages or data transmitted between the user interface 802 and the backend 801. This helps ensure data consistency and prevents invalid or corrupted information from entering the system. In another example, the middleware 810 could be configured to log user activity and system events. This data becomes valuable for auditing purposes, providing insights into system usage, potential security threats, or troubleshooting issues. In still another example, the middleware 810 might handle basic request routing. It could analyze incoming requests and direct them towards the appropriate backend service or component based on pre-defined rules. This can improve overall efficiency by streamlining the flow of communication within the system. By potentially incorporating these additional functionalities, the middleware 810 can evolve from a simple access control layer into a more comprehensive component that enhances the copilot module's security, manageability, and overall performance.

The FLASK main controller 820 serves as the central orchestrator within the copilot module architecture. Its primary function is to manage the overall flow of incoming requests and outgoing responses. The controller is responsible for defining and managing the application's routes, which are essentially the endpoints that can be accessed by clients (e.g., the user interface 802). These routes dictate how incoming requests are mapped to specific functionalities within the system. Upon receiving a request, the controller 820 processes it by extracting relevant information and determining the appropriate course of action. This involves identifying the request type (e.g., WebSocket, HTTP), parsing parameters, and validating input data. After processing the request, the controller 820 coordinates the generation of a suitable response. This might involve interacting with other components, such as handlers or databases, to gather necessary data. The controller 820 then formats the response in a suitable format (e.g., JSON, HTML) and sends it back to the client (e.g. the UI 802). The controller 820 thus acts as a coordinator, directing the flow of data and control between different components within the system. It determines which components need to be involved in processing a specific request and orchestrates their interactions. The controller 820 may also implement error handling mechanisms to gracefully manage unexpected situations or exceptions. It provides informative error messages and takes appropriate actions to recover from errors or prevent system failures. In essence, the FLASK Main Controller 820 acts as the central nervous system of the application, ensuring efficient and coordinated communication between the various components of the copilot nodule 800.

The WebSocket Controller 824 is a specialized component within the copilot module architecture that is dedicated to managing WebSocket connections. Its primary function is to handle real-time communication between the client and the server. The WS Controller establishes 824, maintains, and terminates WebSocket connections 804. It handles connection requests, upgrades HTTP connections to WebSocket, and manages multiple concurrent connections. The component is responsible for receiving and processing WebSocket messages from clients. It parses incoming messages, extracts relevant data, and determines appropriate actions based on message content. The WS Controller 824 facilitates the exchange of data between the client and server in real-time. It enables bidirectional communication, allowing for immediate updates and interactions without the need for constant polling. The WS controller 824 manages WebSocket events, such as connection opening, closing, and error conditions. It implements appropriate logic to handle these events and maintain connection stability. In certain scenarios, the WS Controller might be responsible for broadcasting messages to multiple connected clients. This functionality is useful for disseminating real-time updates or notifications to a group of users. By specializing in WebSocket communication, the WS Controller 824 enables features that require low-latency and interactive user experiences within the copilot module 800.

The REST Controller 826 is a component responsible for handling HTTP-based requests and responses within the copilot module architecture. It adheres to the Representational State Transfer (REST) architectural style, enabling interaction with the system through standard HTTP methods (GET, POST, PUT, DELETE, etc.). The REST Controller processes incoming HTTP requests, extracting relevant information such as request method, URL parameters, headers, and request body. It maps incoming requests to specific resources or endpoints within the system, enabling clients to interact with different parts of the application. After processing the request, the REST Controller constructs appropriate HTTP responses, including status codes, headers, and response bodies. The content of the response is typically generated by interacting with other components within the system. The controller 826 often handles data serialization and deserialization, converting data between different formats (e.g., JSON, XML) for efficient transmission. It implements mechanisms to handle potential errors or exceptions that may occur during request processing, providing informative error messages and appropriate HTTP status codes. By adhering to REST principles, the REST Controller 826 facilitates interoperability, scalability, and maintainability of the copilot module.

The Summarizer component 846 is responsible for generating concise and informative summaries of textual data, specifically within the context of user conversations. The Summarizer 846 accepts textual input, typically in the form of a sequence of messages or a dialogue history. Utilizing natural language processing (NLP) techniques, the summarizer 846 extracts key information and constructs a coherent summary that encapsulates the core points of the original text. The Summarizer 846 aims to preserve the context of the conversation while generating summaries. This involves considering the sequence of messages and identifying relevant information. Depending on the specific requirements, the Summarizer might offer options for customizing the summary length, level of detail, or focus on specific topics. By providing a condensed overview of user interactions, the Summarizer 846 aids in improving user experience, facilitating knowledge retrieval, and supporting various system functionalities such as recommendation generation or conversation analysis.

The Categorizer component 842 is a critical element within the copilot module architecture responsible for classifying incoming user queries 830 into predefined categories 832. This classification serves as a foundational step in determining the appropriate processing path for the query. The Categorizer 842 meticulously examines the incoming user query, dissecting its syntactic and semantic structure. This analysis involves tokenization, part-of-speech tagging, and dependency parsing to extract relevant linguistic features. Building upon the query analysis, the Categorizer 842 identifies the underlying intent or purpose behind the user's query 830. This involves mapping the extracted features to predefined intent categories or utilizing machine learning models trained on labeled data. Based on the recognized intent, the Categorizer 842 assigns the query 830 to a specific category 832 from a predefined set of categories. These categories typically represent different functional areas or domains within the system. To enhance accuracy, the Categorizer 842 considers the conversational context, including previous queries and responses, to refine the classification process. This contextual understanding helps in disambiguating queries that might have multiple interpretations. An important aspect of the Categorizer 842 is its role in implementing guardrails. It acts as a filter, preventing unwanted or irrelevant queries from entering the system. By defining specific criteria or patterns, the categorizer can identify and flag queries that deviate from expected formats or fall outside the system's scope. This helps to maintain system integrity and focus processing efforts on relevant inquiries. By effectively categorizing user queries 830, the categorizer 842 plays a pivotal role in optimizing the query handling process, enabling efficient routing to appropriate components, and ensuring that the system's resources are allocated optimally. Additionally, the guardrail functionality safeguards the system from potential misuse or overload.

The Data Query Handler 860 is a specialized component within the copilot nodule architecture responsible for processing queries related to data retrieval and analysis. If the user has asked for transaction risk summary, it uses a “Transaction Risk Summary Generator” to generate the summary. This component generates a summary of an alerted transaction explaining why that particular transaction is risky. To make the summary concise it follows these steps: (1) Combining multiple risk factors into one sentence. (2) Ordering risk factors according to most alarming first. (3) Excluding some risk factors if the summary is too long. The Data Query Handler 860 analyzes incoming data-related queries to accurately understand the user's data requirements. This involves parsing the query, extracting relevant keywords, and identifying the desired data points or metrics. Based on the query's specifications, the component determines the appropriate data sources or databases to access the required information. This might involve querying metadata repositories or utilizing predefined mappings between query terms and data locations. The Data Query Handler 860 constructs the necessary data retrieval queries, often in the form of structured query language (SQL) statements or API calls, to extract the desired data from the identified sources. This process involves translating natural language query elements into structured query language. The component executes the formulated queries to retrieve the requested data. It may involve interacting with databases, data warehouses, or external data sources. The retrieved data is then processed and transformed as needed to meet the query's requirements. For complex queries, the Data Query Handler 860 might aggregate or summarize the retrieved data to provide meaningful insights. This involves calculations, statistical analysis, or data visualization techniques. The Data Query Handler 860 also implements error handling mechanisms to address potential issues during data retrieval or processing, such as data inconsistencies, missing values, or system errors. By effectively handling data-related queries, the Data Query Handler empowers users to extract valuable insights from the underlying data assets and supports data-driven decision making within the copilot module.

The Product Query Handler 862 is a specialized component within the copilot module architecture designed to process queries related to product information, features, or usage. This component analyzes incoming product-related queries to accurately determine the user's intent and information needs. This involves identifying product names, features, or related keywords. The Product Query Handler 862 accesses relevant product information repositories or knowledge bases to retrieve the necessary data. This might for example involve querying product catalogs, feature databases, or user manuals. The component extracts specific product information based on the user's query. This includes product descriptions, specifications, usage instructions, troubleshooting guides, or other relevant details. The Product Query Handler 862 constructs a clear and informative response based on the retrieved product information, tailoring it to the user's query. This might involve summarizing key points, providing detailed explanations, or offering comparisons between products. In some cases, the component can suggest related products, accessories, or additional information based on the user's query and past behavior. The Product Query Handler 862 also implements error handling mechanisms to address situations where product information is unavailable, ambiguous, or inaccurate. By providing accurate and relevant product information, the Product Query Handler enhances user satisfaction and supports product-related decision making within the copilot module.

The Generic Query Handler 864 is a versatile component within the copilot module architecture designed to process a broad spectrum of queries that do not fall into predefined categories such as data or product queries. The Generic Query Handler 864 employs natural language processing techniques to comprehend the intent and context of incoming queries. It analyzes the query's syntax, semantics, and potential ambiguities. To provide comprehensive and informative responses, the component often relies on a vast knowledge base or information repository. This might encompass a combination of structured data, unstructured text, and external APIs. The Generic Query Handler 864 retrieves relevant information from the knowledge base based on the query's intent. This involves searching for keywords, entities, or concepts within the available data sources. The component then constructs a coherent and informative response based on the retrieved information. This might involve summarizing key points, providing definitions, or offering explanations. To handle queries that cannot be fully answered, the Generic Query Handler 864 might employ fallback strategies such as providing general information, suggesting alternative search terms, or redirecting the user to relevant resources. To improve its capabilities over time, the Generic Query Handler 864 may incorporate feedback mechanisms to learn from user interactions and refine its responses. By handling a wide range of query types, the Generic Query Handler 864 enhances the system's ability to provide informative and helpful responses to users, even when the query does not fit into specific predefined categories.

The Unclear Query Handler 866 is a specialized component within the copilot module architecture designed to address user queries that are ambiguous, incomplete, or lack sufficient context for accurate interpretation. This component thoroughly analyzes the incoming query to identify potential ambiguities, missing information, or conflicting elements. This may for example involve examining syntax, semantics, and context. Based on the identified ambiguities, the Unclear Query Handler 866 generates appropriate clarification questions or requests for additional information. These prompts aim to resolve uncertainties and enable more precise query understanding. Unclear Query Handler 866 interacts with the user to obtain necessary clarifications. This might involve prompting for specific details, offering multiple-choice options, or suggesting alternative phrasings. The Unclear Query Handler 866 may engage in multiple rounds of clarification and query refinement until sufficient information is gathered to proceed with query processing. In cases where clarification attempts are unsuccessful, the component might offer alternative actions, such as suggesting related topics or providing general information. By handling unclear queries effectively, the Unclear Query Handler 866 improves user satisfaction by guiding users towards providing the necessary information and enhancing the overall accuracy of the system's responses.

The Unrelated Query Handler 868 is a component within the copilot module architecture responsible for processing user queries that fall outside the system's defined scope or knowledge domain. This component analyzes incoming queries to determine if they are relevant to the system's capabilities. This involves comparing the query against predefined criteria or using natural language processing techniques to identify topic deviations. When a query is deemed unrelated, the Unrelated Query Handler 868 provides a clear and informative response indicating that the system cannot process the query. This might include suggestions for alternative search engines or information sources. The Unrelated Query Handler 868 helps maintain the system's focus by preventing resource consumption on irrelevant tasks. It ensures that system resources are allocated efficiently to handle queries within its domain. By effectively handling unrelated queries, the Unrelated Query Handler 868 preserves system performance, maintains user expectations, and directs users to appropriate external resources.

The General Responder component 872 serves as a central aggregation and formatting point within the copilot module 800. It consolidates responses from various specialized handlers, applies necessary linguistic enhancements, and presents a coherent and user-friendly final response. The General Responder 872 gathers responses from different handlers, each potentially contributing specific information or fragments to the overall answer. The General Responder 872 combines the individual responses into a cohesive and logical structure, ensuring that the information is presented in a coherent and relevant manner. To enhance user experience, the General Responder 872 employs natural language generation techniques to craft human-like and engaging responses. This involves selecting appropriate vocabulary, sentence structure, and tone. The general responder formats the final response according to the desired output format (e.g., text, structured data) and ensures compatibility with the user interface. The General Responder 872 implements error handling mechanisms to address situations where individual handlers fail to provide responses or when the overall response generation process encounters issues. By acting as a central hub for response consolidation and enhancement, the General Responder 872 plays a crucial role in delivering informative and user-friendly interactions within the copilot module 800.

The Recommender or Recommendation Generator component 848 is responsible for suggesting relevant actions, information, or resources to the user based on the current context, user history, and system capabilities. This component analyzes the current conversation state, user profile, and available system features to identify potential recommendation opportunities. Based on the contextual analysis, the Recommendation Generator 848 produces a list of relevant recommendations 836 tailored to the user's needs. These recommendations 836 can include actions, information, or resources that can enhance the user experience. The Recommendation Generator 848 prioritizes recommendations based on their potential value to the user, considering factors such as relevance, urgency, and user preferences. The Recommendation Generator 848 determines the optimal format and presentation style for the generated recommendations, ensuring clarity and user engagement. To improve recommendation accuracy over time, the Recommendation Generator 848 may incorporate feedback mechanisms to learn from user interactions and refine its recommendations. By proactively suggesting relevant actions, the Recommendation Generator 848 enhances user satisfaction, increases engagement, and guides users towards optimal utilization of the system's capabilities.

Database Models 880 represent the underlying data structures within the copilot module 800. These models define the entities, attributes, and relationships that constitute the system's persistent data. Database models 880 provide the foundation for storing and organizing information critical to the system's operation. This includes user data, conversation history, system configurations, and other relevant data points. These models facilitate efficient retrieval of data by defining access patterns and indexes. This enables various components to query and extract information as needed. Database models 880 enforce data consistency and integrity through constraints, relationships, and validation rules. This helps maintain data accuracy and reliability. The database models 880 define the connections between different data entities, enabling complex queries and data analysis. This facilitates the extraction of insights and trends. The design of database models considers the system's growth and performance requirements. This involves optimizing data structures and indexes for efficient data access and storage. By providing a structured framework for data management, database models 880 ensure the efficient and reliable operation of the copilot module 800. It is noted that specific database models (e.g., User, Session, Context, Conversation Log) mentioned herein may be defined in detail to accurately represent the system's data requirements.

The User Model 882 represents a structured representation of user information within the copilot module architecture. It serves as a repository of user-specific data, enabling personalized interactions and experiences. The User Model 882 stores relevant user attributes such as identification details, preferences, behavior patterns, and interaction history. By capturing user preferences and behavior, the User Model 882 enables tailored recommendations, content suggestions, and interface customizations. The User Model 882 can be integrated with authentication mechanisms to verify user identity and authorize access to specific system functionalities. The User Model 882 facilitates user segmentation based on shared characteristics, enabling targeted marketing or product recommendations. By aggregating and analyzing user data, the User Model 882 contributes to understanding user behavior, preferences, and trends, informing system improvements and decision-making. The User Model 882 may be a dynamic entity that evolves as users interact with the system, allowing for continuous refinement of the user experience.

The Session Model 884 represents a dynamic instance of user interaction within the copilot architecture. It encapsulates the stateful information associated with a specific user session, enabling context-aware interactions and personalized experiences. The Session Model 884 tracks the life cycle of a user session, including its initiation, active state, and termination. It manages session identifiers, timeouts, and related metadata. The Session Model 884 stores temporary data relevant to the current user interaction, such as conversation history, user preferences, and intermediate results. This information is accessible within the session's lifespan. The Session Model 884 captures contextual data about the user's interaction, including the current dialogue state, previous queries, and system responses. This enables coherent and personalized interactions. The Session Model 884 incorporates security measures to protect sensitive session data from unauthorized access. This includes mechanisms for session authentication and encryption. To enhance system performance, the Session Model 884 may employ caching or compression techniques to optimize data storage and retrieval. By managing session-specific information, the Session Model 884 facilitates seamless and personalized user experiences within the copilot module 800.

The Context Model or Context Store Model 886 represents a structured representation of the relevant environmental factors and user-specific information that influence the current interaction. It serves as a dynamic repository of contextual data essential for providing personalized and relevant responses. The Context Model 886 captures and stores various contextual elements such as user location, device information, time, weather, and other relevant environmental factors. This component enriches the context by incorporating additional information from external sources or knowledge bases to enhance the understanding of the user's situation. The Context Model 886 enables the system to infer implicit information or user intent based on the available contextual data. This supports more nuanced and intelligent responses. The Context Model 886 is designed to be updated continuously as the user's environment or interaction evolves, ensuring that the system has access to the latest relevant information. The Context Model 886 adheres to privacy regulations and security best practices to protect sensitive user data. By providing a comprehensive understanding of the user's context, the Context Model 886 empowers the system to deliver highly personalized and relevant experiences.

The Conversation Log Model 888 serves as a repository for recording and storing the historical interactions between a user and the copilot module 800. It provides a structured representation of the conversational flow, facilitating analysis, improvement, and future interactions. The Conversation Log Model 888 captures and stores a chronological record of user queries, system responses, and relevant metadata associated with each interaction. By analyzing the conversation history, this component enables the identification of patterns, trends, and user preferences, contributing to system improvements and personalized experiences. The Conversation Log Model 888 supports the analysis of user behavior, allowing for the identification of common user goals, challenges, and satisfaction levels. The stored conversation data can be utilized as training data for machine learning models, enhancing the system's ability to understand and respond to user queries. The Conversation Log Model 888 plays a role in meeting compliance requirements by providing a record of user interactions for auditing and regulatory purposes. By preserving a detailed history of conversations, the Conversation Log Model 888 enables valuable insights and improvements to the copilot module 800 while respecting user privacy and data protection guidelines.

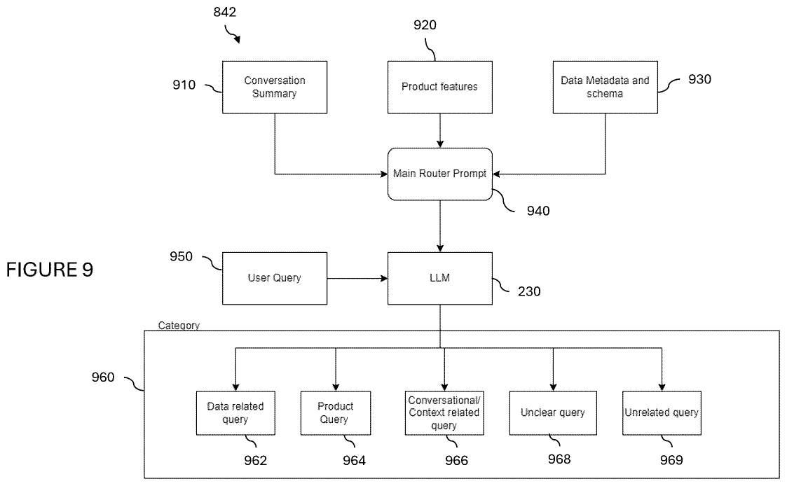

FIG. 9 is a schematic, diagrammatic representation, in block diagram form, of at least a portion of an example categorizer 842, in accordance with at least one embodiment of the present disclosure. In the example shown in FIG. 9, a conversation summary 910, produce features 920, and data, metadata, and schema 930 are used to construct a main router prompt 940, which is passed to the LLM 230 along with a fresh user query 950. The user query 950 is then sorted into a category 960, which may for example include a data-related query 962, a produce query 964, a conversational or context-related query 966, an unclear query 968, or an unrelated query 969, as described above.

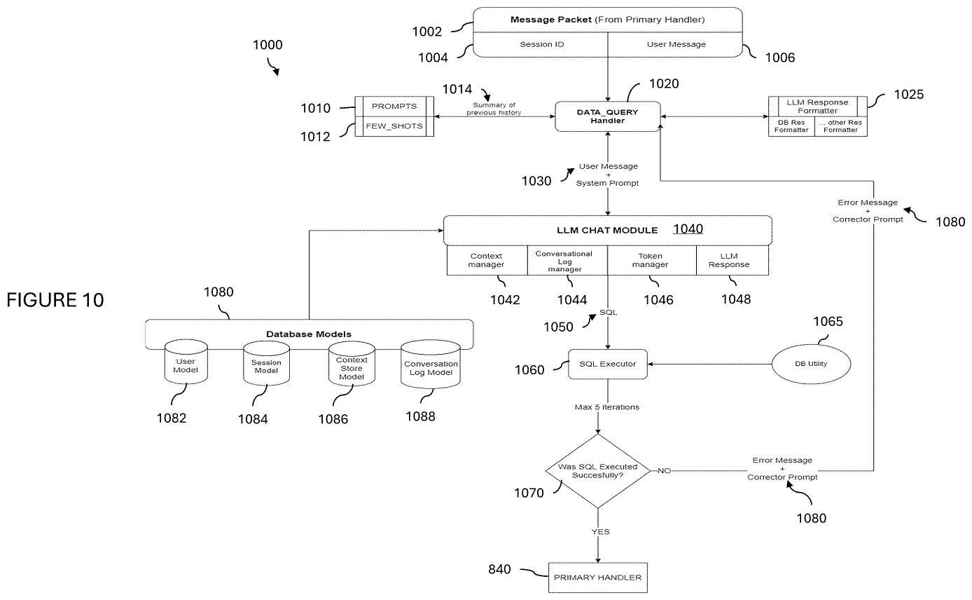

FIG. 10 is a schematic, diagrammatic representation, in block diagram form, of at least a portion of an example verification script generation system 1000, in accordance with at least one embodiment of the present disclosure. In the example shown in FIG. 10, a message packet 1002 is received from the primary handler. The message packet 1002 includes a session ID 1004 and a user message 1006. The message packet 1002 is passed to the data query handler 1020, which also receives a summary of previous history 1014, including prompts and FEW_SHOTS (e.g., examples of data related queries (962), product queries (964), context-related queries (966) and unclear/unrelated (968/969) queries and the expected answer for the same). The data query handler 1020 also communicates with an LLM response formatter 1025, which may for example include a database response formatter and an “other” response formatter. Here the system informs the LLM about how its response should be formatted, for example JSON format (including expected keys in JSON) or SQL format (DB response format) or CSV format. This makes it easier to parse the response to gather required information from the LLM response in later steps.

The data query handler 1020 passes a prompt 1030 (e.g., a user message combines with a system prompt) to the LLM chat module or summary engine 1040, which includes a context manager 1042, a conversational log manager 1044, a token manager 1046, and an LLM response 1048. The LLM chat module receives data from the database models 1080, including the user model 1082, session model 1084, context model or context store model 1086, and conversation log model 1088.

The LLM chat module 1040 produces an SQL query 1050, which is passed to an SQL executor 1060. The system then performs a check 1070 to see whether the SQL was executed successfully. If no, an error message and corrector prompt 1080 is passed back to the data query handler 1020, and the process repeats, for a maximum of 5 iterations. If yes, the output of the SQL executor 1060 is passed to the primary handler 840.

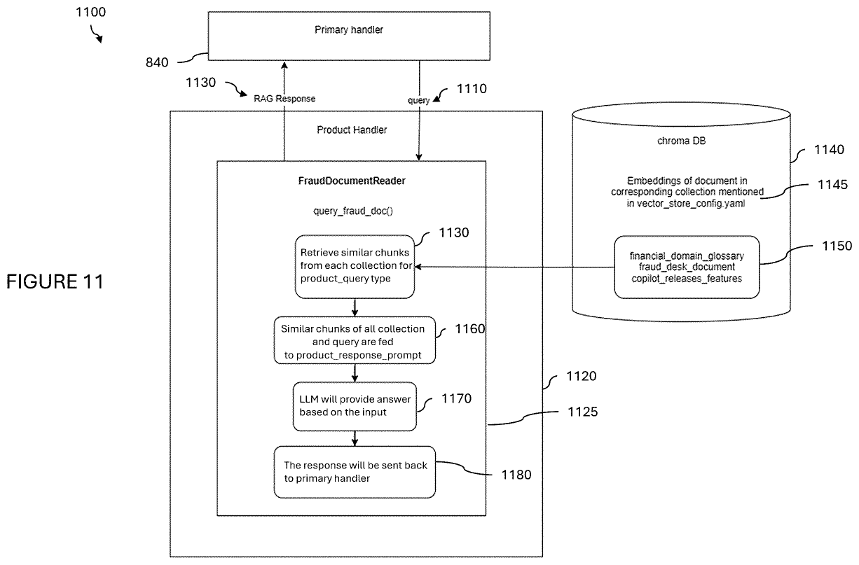

FIG. 11 is a schematic, diagrammatic representation, in block diagram form, of at least a portion of an example verification script generation system 1100, in accordance with at least one embodiment of the present disclosure. In the example shown in FIG. 11, the primary handler 840 passes a query 1110 to the produce handler 1120, which includes a fraud document reader 1125. Within the fraud document reader, the following steps are performed

In step 1130, the fraud document reader 1125 retrieves similar chunks from each collection for the product query type, from a chroma database 1140 containing embeddings 1145 of documents 1150 in a corresponding collection in vector space, where the documents may for example include a financial domain glossary, a fraud desk document, and a copilot release features document. The product query is embedded in the same vector space. The chroma database vectors are queried for the most similar vectors (chunks from documents are embedded into vectors and stored in chroma database) to the product query. These are used to retrieve the right chunks from the documents for this particular product query.

In step 1160, the output of step 1130 is used to construct a product response prompt.

In step 1170, the product response prompt is passed to the LLM.

In step 1180, the LLM's retrieval augmented generation (RAG) response 1130 is passed back to the primary handler 840, and may for example be passed back to the GUI for display to a user such as a fraud analyst, or may be used as a script for an IVR system to call or text the customer.

Generally speaking, the prompt produced at step 1160 will generally use layman's language (e.g., no technical jargon, such as risk factor names), and the output should be concise so as to keep the customer's attention until the message is fully delivered. The system can do this by combining multiple risk factors into one sentence, ordering risk factors according to most alarming first, and excluding some risk factors if the message is too long. The response should also be free of fearmongering terms such as “your account will be frozen pending an immediate response”, “Your funds are at extreme risk of being lost forever.”, or “Ignoring this message will put your financial future in jeopardy”. The prompt should not require constant tweaking. In an example, only risk factors that are added in the fraud detection product may need to be changed.

Example risk factors (e.g., from a wire fraud product) include:
ABA_Risk—New or Infrequent beneficiary FI
BeneLoc—New or Infrequent beneficiary location
BeneTrust—New or infrequent beneficiary
Drawdown_Beta_Risk—Unusual or infrequent use of drawdown request
OBIInst_RAdisplay—Potential risk in originator to beneficiary Instructions
OBI_Beta_Risk—New or infrequent use of originator to beneficiary instructions
OrigMethod—New or infrequent change in origination method
OrigTransAmt—Unusual transaction amount
OrigTrust—New or infrequent originator
OrigVelocity—Unusual change in the frequency of transfers for this originator
PayMthd—New or infrequent change in payment method: (domestic Iinternational)
MuleRisk—The account for recipient appears on one or more suspicious or compromised account watch lists
TrsfrDirection—New or infrequent change in transfer direction
timeOfWeekRisk—Unusual day of week or day of month for transfer
TRecipAcctDtl—Unusual account number: beneficiary name combination found for recipient {beneficiary_identifier}: {beneficiary_name}

These risk factor definitions, along with their relative criticality with respect to one another, may be included in the custom prompt. For example, the risk factors may be listed in order of decreasing criticality. In an example where the risk factors included: OrigTransAmt, OBIFreq, and MuleRisk, then the output was:

“We noticed a transaction made by you to Anushri Builders Inc for $10,000 in Mumbai. This transaction stands out as the recipient's account appears on a known list of suspicious account holders. Additionally, the amount is significantly lower than your usual range of $500,000 to $1,000,000.”

Things to note: MuleRisk is described first since it is the most alarming (refer to high level design document below). Transaction Amount Risk is listed later since the amount is lower than usual and so not very alarming. OBIFreq is omitted to keep the message concise.

In a different example where the risk factors included: BeneLoc, BeneTrust, OrigTransAmt, MuleRisk, and timeOfWeekRisk, then the output was:

“We noticed some unusual activity in your recent transaction with Prabhat Organization for $70,000 in Mumbai. This is significantly higher than your usual transaction amount range of $5,000 to $10,000 and was made to an account that appears on suspicious watch lists. You haven't done many transactions with this party, and you don't often send transactions to Mumbai either.”

Things to note: TimeofWeekRisk was omitted. What was mentioned first captures the most attention: the amount is significantly higher than the average historical transactions. Multiple risk factors were combined into one sentence.

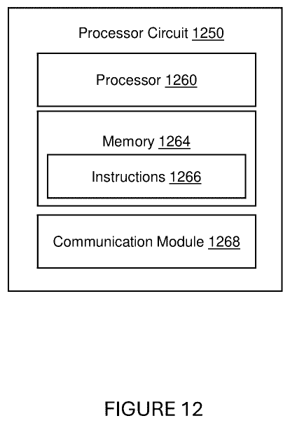

FIG. 12 is a schematic diagram of a processor circuit 1250, in accordance with at least one embodiment of the present disclosure. The processor circuit 1250 may be implemented in the system 100, the system 200, the system 300, or other devices or workstations (e.g., third-party workstations, network routers, etc.), or on a cloud processor or other remote processing unit, as necessary to implement the method. As shown, the processor circuit 1250 may include a processor 1260, a memory 1264, and a communication module 1268. These elements may be in direct or indirect communication with each other, for example via one or more buses.

The processor 1260 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1260 may also comprise another hardware device, a firmware device, or any combination thereof configured to perform the operations described herein. The processor 1260 may also be implemented as a combination of computing devices, e.g., a combination of a DSP and a microprocessor, a plurality of microprocessors, one or more microprocessors in conjunction with a DSP core, or any other such configuration.

The memory 1264 may include a cache memory (e.g., a cache memory of the processor 1260), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1264 includes a non-transitory computer-readable medium. The memory 1264 may store instructions 1266. The instructions 1266 may include instructions that, when executed by the processor 1260, cause the processor 1260 to perform the operations described herein. Instructions 1266 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1268 can include any electronic circuitry and/or logic circuitry to facilitate direct or indirect communication of data between the processor circuit 1250, and other processors or devices. In that regard, the communication module 1268 can be an input/output (I/O) device. In some instances, the communication module 1268 facilitates direct or indirect communication between various elements of the processor circuit 1250 and/or the system 100, 200, 300, etc. The communication module 1268 may communicate within the processor circuit 1250 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or communication with the customer or fraud analyst) may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the verification script generation system advantageously provides for automatic generation of an alert-specific, context-specific transaction verification call script, along with automatic placement of the call (or text, etc.) and interpretation of the customer's response. Accordingly, it can be seen that the verification script generation system fills a long-standing need in the art, by eliminating the time spent by fraud analysts composing and reading scripts, placing calls, etc.

A number of variations are possible on the examples and embodiments described above. For example, scripts for applications other than fraud detection may be generated according to the methods described herein. Other risk factors may be used than those described herein. Any LLM may be used, including a combination of different LLMs tailored to perform specific functions described herein or alternative chatbot technologies that produce a similar effect.

Accordingly, the logical operations making up the embodiments of the technology described herein are referred to variously as operations, steps, objects, elements, components, or modules. Furthermore, it should be understood that these may occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the verification script generation system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the verification script generation system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

1. A system adapted to automatically verify a suspicious transaction, the system comprising:
a fraud analyst computing device having a processor and a non-transitory computer readable medium operably coupled thereto, the fraud analyst computing device comprising a graphical user interface (GUI) and a risk factor identification module and being in electronic communication with a financial institution computer system and a summary engine, the non-transitory computer readable medium comprising a plurality of instructions stored in association therewith that are accessible to, and executable by, the processor, to perform operations which comprise:
electronically receiving, from the financial institution computer system, an alerted transaction associated with a customer;
with the risk factor identification module, automatically identifying a plurality of risk factors associated with the alerted transaction;
electronically transmitting the plurality of risk factors and a custom prompt to the summary engine; and
electronically receiving, from the summary engine, a transaction verification call script based on the plurality of risk factors and the custom prompt.

2. The system of claim 1, wherein the operations further comprise:
with the GUI, within 1 second of receiving the alerted transaction, displaying the transaction verification call script to a user.

3. The system of claim 1, wherein the operations further comprise:
automatically contacting the customer associated with the alerted transaction;
based on the customer being reached by the contact:
automatically communicating the transaction verification call script to the customer;
automatically requesting, from the customer, an indication of whether the alerted transaction is valid or fraudulent;
automatically receiving and interpreting the indication from the customer, and
based on the indication indicating that the alerted transaction is fraudulent, automatically blocking the alerted transaction.

4. The system of claim 1, wherein the operations further include:
automatically contacting the customer associated with the alerted transaction;
based on the customer not being reached by the contact:
automatically placing a hold on the alerted transaction; and
with the GUI, displaying the alerted transaction to a user.

5. The system of claim 3, wherein the operations further comprise receiving, via the GUI, from a user, an instruction to contact the customer.

6. The system of claim 3, wherein the fraud analyst computing device further comprises an interactive voice response (IVR) system, and wherein the contact is an automated voice contact generated by the IVR system.

7. The system of claim 1, wherein the summary engine comprises a large language model.

8. The system of claim 1, wherein the custom prompt includes corresponding definitions and criticalities for the plurality of risk factors.

9. The system of claim 1, wherein the custom prompt includes instructions to avoid technical jargon, to be concise, and to avoid fearmongering.

10. The system of claim 1, wherein the custom prompt includes instructions to mention at least some of the plurality of risk factors in a single sentence, in order of corresponding criticalities.

11. A computer-implemented method, comprising:
with a fraud analyst computing device having a processor and a non-transitory computer readable medium operably coupled thereto, the fraud analyst computing device comprising a graphical user interface (GUI) and a risk factor identification module and being in electronic communication with a financial institution computer system and a summary engine, the non-transitory computer readable medium comprising a plurality of instructions stored in association therewith that are accessible to, and executable by, the processor:
electronically receiving, from the financial institution computer system, an alerted transaction associated with a customer;
with the risk factor identification module, automatically identifying a plurality of risk factors associated with the alerted transaction;
electronically transmitting the plurality of risk factors and a custom prompt to the summary engine; and
electronically receiving, from the summary engine, a transaction verification call script based on the plurality of risk factors and the custom prompt.

12. The computer-implemented method of claim 11, wherein the operations further comprise:
with the GUI, within 1 second of receiving the alerted transaction, displaying the transaction verification call script to a user.

13. The computer-implemented method of claim 11, wherein the operations further comprise:
automatically contacting the customer associated with the alerted transaction;
based on the customer being reached by the contact:
automatically communicating the transaction verification call script to the customer;
automatically requesting, from the customer, an indication of whether the alerted transaction is valid or fraudulent;
automatically receiving and interpreting the indication from the customer; and
based on the indication indicating that the alerted transaction is fraudulent, automatically blocking the alerted transaction.

14. The computer-implemented method of claim 13, wherein the operations further include:
automatically contacting the customer associated with the alerted transaction;
based on the customer not being reached by the contact:
automatically placing a hold on the alerted transaction; and
with the GUI, displaying the alerted transaction to a user.

15. The computer-implemented method of claim 13, wherein the operations further comprise receiving, via the GUI, from a user, an instruction to contact the customer.

16. The computer-implemented method of claim 13, wherein the fraud analyst computing device further comprises an interactive voice response (IVR) system, and wherein the contact is an automated voice contact generated by the IVR system.

17. The computer-implemented method of claim 11, wherein the summary engine comprises a large language model.

18. The computer-implemented method of claim 11, wherein the custom prompt includes corresponding definitions and criticalities for the plurality of risk factors.

19. The computer-implemented method of claim 11, wherein the custom prompt includes instructions to avoid technical jargon, to be concise, and to avoid fearmongering.

20. The computer-implemented method of claim 11, wherein the custom prompt includes instructions to mention at least some of the plurality of risk factors in a single sentence, in order of corresponding criticalities.
